(19) United States
(12) Patent Application Publication
(10) Pub. No.: US 2007/0192841 A1
(43) Pub. Date: Aug. 16, 2007

(54) Mutual authentication apparatus and method

(75) Inventor: Hee Jean Kim, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/638,576

(22) Filed: Dec. 14, 2006

(30) Foreign Application Priority Data
Feb. 15, 2006 (KR) 10-2006-0014669

(51) Int. Cl. H04L 9/32

(52) U.S. Cl. 726/5

(57) ABSTRACT

A mutual authentication apparatus and method for using the Internet, including a user authentication code generator and a server authentication code generator which execute mutual authentication between a user and a server by generating a server authentication code required for the access to the server using an authentication code generating function based on time information provided from a mobile communication network or a global positioning system (GPS) satellite, accessing the server with the generated server authentication code, generating a user authentication code using an authentication code generating function at the accessed server, and providing the generated user authentication code to the user.

### CROSS-REFERENCE TO RELATED APPLICATIONS

This application claims priority under 35 U.S.C. §119 (a) from Korean Patent Application No. 10-2006-0014669 filed on Feb. 15, 2006 in the Korean Intellectual Property Office, the entire disclosure of which is incorporated herein by reference.

### BACKGROUND OF THE INVENTION

1. Field of the Invention

Methods and apparatuses consistent with the present invention relate to mutual authentication. More particularly, the present invention relates to mutual authentication apparatus and method for executing mutual authentication between a user and a server by generating a server authentication code required for the access to the server using an authentication code generating function based on time information provided from a mobile communication network or a global positioning system (GPS) satellite, accessing the server with the generated server authentication code, generating a user authentication code using an authentication code generating function at the accessed server, and providing the generated user authentication code to the user.

2. Description of the Related Art

Recently, there have been attempts to steal private information from users by directing them to log in to a counterfeit website which is constructed similar to world-famous websites such as Yahoo. These attempts are commonly referred to as “phishing.”

The term phishing is derived from the terms “private data” and “fishing”, and includes the gathering of the private information. Additionally, phishing refers to a new type of deception in which Internet users may be tracked using counterfeit websites or e-mails to steal their private information such as an identification (ID), password, credit card number, and the like.

One method of phishing is to lure users to input their private information by sending massive e-mails which appear to be sent from a financial organization. The website linked to the e-mail is the real website of the legitimate financial organization, but the user is lured to input his/her private information through an illegitimate pop-up window.

In addition, a perpetrator may acquire users' private information by directing them to a simulated Yahoo website, which is a bogus version of the world-famous Yahoo website, and thus, tricking them logging into the simulated Yahoo website.

Authenticating a user's access to the server and authenticating whether the server accessed by the user is a legitimate server may prevent the phishing scam from impacting a user.

However, in related art authentication methods, the server sends an authentication number to a user's portable terminal in the form of a short message service (SMS) message over a mobile communication network, and the user inputs the received authentication number in the website. Thus, as the user does not know whether the accessed server is the intended legitimate server, the authentication number provided from the fake server is received and used to access the fraudulent server.

As such, it may be difficulte to prevent the phishing scams because there is no way to authenticate the server currently accessed by the user and the server authenticates the user using a one-way authentication technique.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above. Accordingly, an aspect of the present invention provides a mutual authentication apparatus and method for executing mutual authentication between a user and a server by generating a server authentication code required for the access to the server using an authentication code generating function based on time information provided from a mobile communication network or a global positioning system (GPS) satellite, accessing the server with the generated server authentication code, generating a user authentication code using an authentication code generating function at the accessed server, and providing the generated user authentication code to the user.

According to an aspect of the present invention, there is provided a mutual authentication apparatus for generating authentication codes required for mutual authentication with a server based on time information T which is provided over a communication network, including a user authentication code generator which generates a user authentication code using an authentication code generating function; and a server authentication code generator which generates a server authentication code using the authentication code generating function.

The mutual authentication apparatus may be applied to a mobile terminal including a PDA and a Wibro phone.

The mutual authentication apparatus may further include a time information receiver which receives the time information (T); and a display which displays the user authentication code and the server authentication code.

The authentication code generating function may use secret information (X, Y) which is shared with the server, and the time information T.

The user authentication code and the server authentication code may be generated within a synchronization interval in which synchronization is conducted according to a network condition.

According to another aspect of the present invention, a mutual authentication method of a user terminal, includes a time information receiving operation of receiving time information T over a communication network; a user authentication code generating operation of generating a user authentication code using an authentication code generating function based on the time information; and a user authentication code displaying operation of displaying the user authentication code.

The authentication code generating function may use secret information X shared with a server which authenticates the user terminal, and the time information T.

The user authentication code may be generated within a synchronization interval in which synchronization is conducted according to a network condition.

According to another aspect of the present invention, a mutual authentication method of a server includes a user authenticating operation of performing user authentication based on a user authentication code received from a user terminal; a server authentication code generating operation of generating a server authentication code using the user authentication code and an authentication code generating function; and a server authentication code displaying operation of displaying the server authentication code to be recognized by a user.

The user authentication code may contain secret information X shared with the user terminal, and time information T.

The user authenticating operation may generate a user authentication code with the authentication code generating function based on the user authentication code, and perform the user authentication according to whether the generated user authentication code matches the received user authentication code.

The server authentication code generating operation may generate the server authentication code by applying the secret information, which is contained in the user authentication code, to the authentication code generating function.

### BRIEF DESCRIPTION OF THE DRAWING FIGURES

These and/or other aspects of the present invention will become more apparent and more readily appreciated from the following description of exemplary embodiments thereof, with reference to the accompanying drawings, in which:

FIG. 1 is a simplified block diagram of a mutual authentication system to which a mutual authentication method is applied according to an exemplary embodiment of the present invention;

FIG. 2 is a simplified block diagram of the user terminal;

FIG. 3 is a flowchart outlining a mutual authentication method according to an exemplary embodiment of the present invention; and

FIG. 4 is a view illustrating a cycle of synchronization between the user terminal and the server.

### DETAILED DESCRIPTION OF EXEMPLARY EMBODIMENTS

Certain exemplary embodiments of the present invention will now be described in greater detail with reference to the accompanying drawings.

In the following description, the same drawing reference numerals are used to refer to the same elements, even in different drawings. The matters defined in the following description, such as detailed construction and element descriptions, are provided as examples to assist in a comprehensive understanding of the invention. Also, well-known functions or constructions are not described in detail, since they would obscure the invention in unnecessary detail.

FIG. 1 is a simplified block diagram of a mutual authentication system to which a mutual authentication method is applied according to an exemplary embodiment of the present invention.

A user authentication system, which the present invention is applied to, includes a user terminal 110, a mobile communication network 120, Internet 130, a user personal computer (PC) 132, and a server 140.

The user terminal 110 may be a mobile phone, a personal digital assistant (PDA), a Wibro phone, or any mobile terminal, which enables a user to connect to a website of the Internet 130 over the mobile communication network 120. The user terminal 110 generates a user authentication code required for the user authentication and a server authentication code required for the server authentication according to an authentication code generating function. For doing so, the user terminal 110 shares secret information (X, Y) with the server 140.

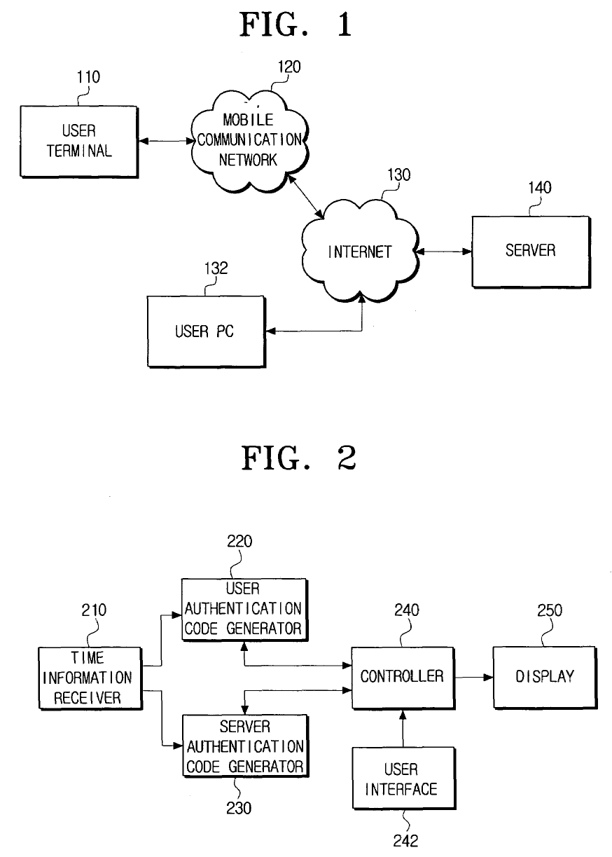

The user terminal 110 may be a terminal which utilizes phone call or multimedia services over a circuit switched network (CSN) and a packet switched network (PSN). The user terminal 110 may execute packet and audio data communications using asynchronous wideband code division multiple access (WCDMA) networks. The construction of the user terminal 110 will be further explained in reference to FIG. 2.

The mobile communication network 120 includes a radio base station and a mobile switching center (MSC). The radio base station is a terrestrial infrastructure for the mobility of the user terminal 110. The radio base station provides a communication connection path or a wireless Internet connection path for wireless phone calls of the user terminal 110. The radio base station is also responsible for the handoff and the wireless support management. The radio base station includes a base transceiver station (BTS) and a base station controller (BSC).

The BTS receives a connection request signal or a call request signal from the user terminal 110 through a traffic channel of signal channels, and forwards the connection request signal or the call request signal received from the user terminal 110 to the BSC. In addition, the BTS is a network endpoint device directly connected to the user terminal 110 by performing baseband signal processing, wire and wireless conversion, and transmission and reception of radio signals.

The BSC controls the BTS, and performs radio channel allocation and clearing for the user terminal 110, Tx output controls of the user terminal 110 and the BTS, inter-cell soft handoff and hard handoff determination, transcoding and vocoding, GPS clock distribution, operation and maintenance of the base station, and the like.

The MSC processes basic and additional services, outgoing and incoming calls of a subscriber, location registration process and handoff process, interworking with another network, and so forth. The MSC of an IS-95 A/B/C system includes an access switching subsystem (ASS) for processing distributed calls, an interconnection network subsystem (INS) for processing centralized calls, a central control subsystem (CCS) for managing centralization of operation and maintenance, and a location registration subsystem (LRS) for storing and managing mobile subscriber information.

As for the asynchronous network, the mobile communication network 120 includes a radio transceiver subsystem (RTS), a radio network controller (RNC), and a MSC. The RTS serves as a wireless connection endpoint to the user terminal 110 in conformity with 3rd generation partnership project (3GPP) wireless connection specification, transmits and receives audio, video and data traffics in the WCDMA scheme, and transmits and receives information to and from the user terminal 110 via a transceiver antenna. Typically, the intra subsystem of the RTS includes a base station interconnection subsystem (BIS), a base band subsystem (BBS), and a radio frequency subsystem. These subsystems are well-known technologies and, thus, are not described further for conciseness.

The RNC is responsible for the wire and wireless channel management, the user terminal protocol matching, the base station protocol matching, the soft handoff processing, the core network protocol processing, the general packet radio service (GPRS) connection, the failure handing, and the system loading. The GPRS is an asynchronous communication service which supports a data transfer rate of 115 Kbps, provides multimedia mails, and maximizes efficiency of the transmission line by virtue of packet-by-packet data transfer.

The MSC has a soft switching structure to rapidly process the calls in addition to the basic functions for the voice calls. Herein, the soft switching is a technique to process audio, data, and video signals using a high-speed packet switch by upgrading a circuit switch of the related art switching system to a software switch.

Although the mobile communication network 120 includes an element management system, a home location register (HLR), and a visitor location register (VLR), they are well-known techniques and not illustrated further for conciseness.

The Internet 130 is a communication network in conformity with Internet protocol (IP). The Internet 130 provides paths for transmitting and receiving data between remote terminals and a path for connecting to the server 140 by the user terminal 110.

The user PC 132 is a terminal through which the user accesses the server 140 via the Internet 130 and receives Internet web services from the server 140. The user PC 132 also transmits the authentication code input from the user, to the server 140.

The server 140 performs the user authentication based on the user authentication code that is input when the user PC 132 accesses the server 140 over the Internet 130, generates and displays a server authentication code using the same authentication code generating function as used by the user terminal 110. The server 140 generates the server authentication code with the secret information contained in the user authentication code. Accordingly, the server 140 shares the secret information with the user terminal 110.

FIG. 2 is a simplified block diagram of the user terminal 110.

Referring now to FIG. 2, the user terminal 110 includes a time information receiver 210, a user authentication code generator 220, a server authentication code generator 230, a controller 240, a user interface 242, and a display 250.

The time information receiver 210 receives time information which is provided from the mobile communication network 120 basically, or a GPS satellite.

The user authentication code generator 220 generates a user authentication code using a user authentication code generating function F(X, T). In the user authentication code generating function F(X, T), X is the secret information shared with the server 140 and T is the time information forwarded from the time information receiver 210. Note that F can be a secure function in view of cryptography, for example, an encryption algorithm or a hash function.

The server authentication code generating function 230 generates a server authentication function using a server authentication code generating function G(Y, T). In the server authentication code generating function G(Y, T), Y is the secret information shared with the server 140 and T is the time information forwarded from the time information receiver 210. Likewise, G can be a secure function in view of cryptography, for example, an encryption algorithm or a hash function.

Accordingly, the functions F and G or the secret information X and Y can use the same value. In more detail, the user authentication code or the server authentication code may be generated separately by varying X and Y with the same function.

When the user inputs a user authentication code generation command through the user interface 242, the controller 240 controls the user authentication code generator 220 to generate the user authentication code based on the time information provided from the time information receiver 210. When a server authentication code generation command is input through the user interface 242, the controller 240 controls the server authentication code generator 230 to generate the server authentication code based on the time information. In addition, the controller 240 controls the display 250 to display the generated user authentication code or the generated server authentication code.

The user interface 242 may be a key input device having a plurality of buttons so that the user can input the user authentication code generation command or the server authentication code generation command. The user interface 242 may have a plurality of characters or numbers to input commands relating to the phone call or the data transfer over the mobile communication network 120.

The display 250 displays an operation state of the user terminal 110, or the user authentication code or the server authentication code so that the user can look at it.

Although the user terminal 110 further includes a construction for the wireless phone call and a construction for the data transmission and reception via the mobile communication network 110 in addition to the above-mentioned structure, these constructions are well-known in the art and, thus, omitted for clarity.

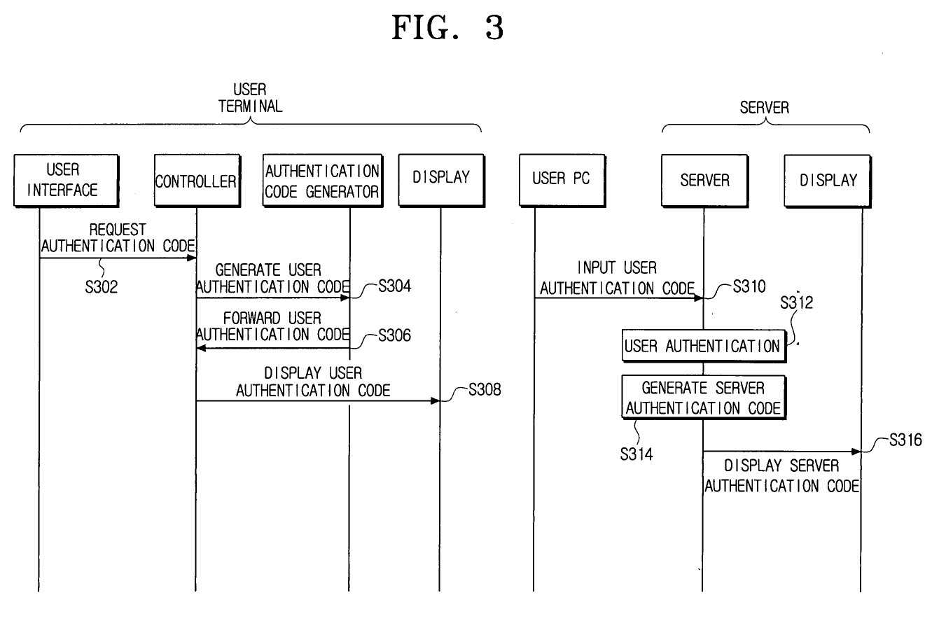

FIG. 3 is a flowchart outlining a mutual authentication method according to an exemplary embodiment of the present invention.

First, the user accesses to the server 140 using the user PC 132 via the Internet 130 in order to use a financial service at a website provided from the server 140.

The server 140 requests the input of the authentication code to authenticate the accessed user PC 132.

In response to this, the user inputs a user authentication code request command using the user interface 242 of the user terminal 110 which is carried along by the user. Hence, the user interface 242 forwards the user authentication code request command to the controller 240 (operation S302).

The controller 240 controls the user authentication code generator 220 to generate the user authentication code based on the time information received via the time information receiver 210 (operation S304).

The user authentication code generator 220 generates the user authentication code with the user authentication code generating function F(X, T) and sends the generated user authentication code generating function to the controller 240 (operation S306).

The controller 240 controls to display the generated user authentication code on the display 250 (operation S308).

Therefore, the user can confirm the user authentication code displayed on the display 250 of the user terminal 110.

The user inputs the user authentication code to the user PC 132 and accordingly, the user authentication code is forwarded from the user PC 132 to the server 140 (operation S310).

The server 140, upon receiving the user authentication code from the user PC 132, generates a user authentication code by applying the secret information of the user authentication code to the authentication code generating function, and determines whether the generated user authentication code matches the received user authentication code. When the two user authentication code match according to a result of the determination, the server 140 performs the user authentication with respect to the user PC 132 so that the user PC 132 can use services including the financial service (operation S312).

Next, the server 140 generates a server authentication code with an authentication code generating function so that the user can confirm it is the legitimate server (operation S314).

The server 140 displays the generated server authentication code on the website (operation S316).

Hence, the user can confirm the server authentication code provided from the server 140 through the website displayed on the user PC 132.

Next, the user inputs a command relating to the server authentication code request using the user interface 242 of the user terminal 110.

Hence, the controller 240 of the user terminal 110 controls the server authentication code generator 230 to generate a server authentication code with the server authentication code generating function based on the time information received via the time information receiver 210.

The controller 240 displays the server authentication code, which is generated at the server authentication code generator 230, on the display 250.

Accordingly, the user confirms the server authentication code displayed on the display 250, and compares whether the server authentication code matches the server authentication code displayed on the website of the user PC 132. As such, since the user confirms the accessed server 140 is a legitimate server, the mutual authentication between the user and the server can be achieved.

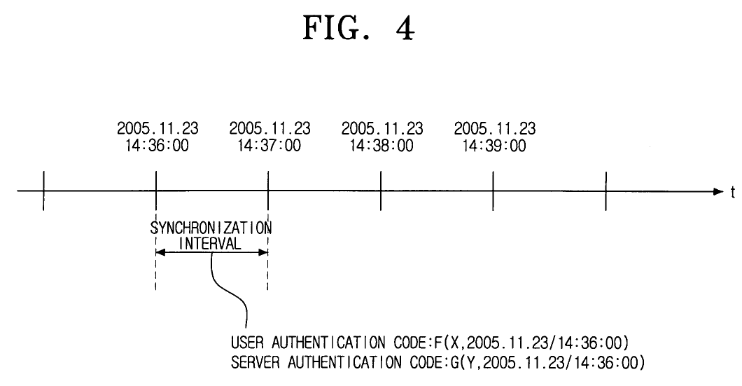

Meanwhile, to use the authentication code generating function, the user terminal 110 and the server 140 are synchronized to operate at the same time. As shown in FIG. 4, the synchronization can be executed at intervals of 1 minute in which both of the user authentication code and the server authentication code can be generated. More specifically, the synchronization can be executed at 14:36 in Nov. 23, 2005, at 14:37 in Nov. 23, 2005, at 14:38 in Nov. 23, 2005, and at 14:39 in Nov. 23, 2005.

In case that the synchronization interval is within 1 minute, the user terminal 110 and the server 140 generate the user authentication code and the server authentication code with the user authentication code generating function F(X, 2005.11.23/14:36:00) and the server authentication code generating function G(Y, 2005.11.23/14:36:00) at 14:36 in November 23, 2005.

As set forth above, there is no need to use a timer or a timer function for the sake of the synchronization between the user terminal and the server.

Furthermore, since it is unnecessary to use the network to transmit the authentication codes, the Internet scams such as phishing can be prevented by virtue of the mutual authentication. The user can confirm whether the accessed server is the intended legitimate server.

While the present invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A mutual authentication apparatus for generating authentication codes for mutual authentication with a server based on time information (T) which is provided over a communication network, comprising:
a user authentication code generator which generates a user authentication code using an authentication code generating function; and
a server authentication code generator which generates a server authentication code using the authentication code generating function.

2. The mutual authentication apparatus as in claim 1, wherein the mutual authentication apparatus is applied to a mobile terminal including a PDA and a Wibro phone.

3. The mutual authentication apparatus as in claim 1, further comprising:
a time information receiver which receives the time information T; and
a display which displays the user authentication code and the server authentication code.

4. The mutual authentication apparatus as in claim 1, wherein the authentication code generating function uses secret information (X, Y) which is shared with the server, and the time information T.

5. The mutual authentication apparatus as in claim 1, wherein the user authentication code and the server authentication code are generated within a synchronization interval in which synchronization is conducted according to a network condition.

6. A mutual authentication method of a user terminal, comprising:
receiving time information T over a communication network;
generating a user authentication code using an authentication code generating function based on the time information; and
displaying the user authentication code.

7. The mutual authentication method as in claim 6, wherein the authentication code generating function uses secret information X shared with a server which authenticates the user terminal, and the time information T.

8. The mutual authentication method as in claim 6, wherein the user authentication code is generated within a synchronization interval in which synchronization is conducted according to a network condition.

9. A mutual authentication method of a server, comprising:
performing user authentication based on a user authentication code received from a user terminal;
generating a server authentication code using the user authentication code and an authentication code generating function; and
displaying the server authentication code to be recognized by a user.

10. The mutual authentication method as in claim 9, wherein the user authentication code contains secret information X shared with the user terminal, and time information T.

11. The mutual authentication method as in claim 9, wherein the user authenticating operation generates a user authentication code with the authentication code generating function based on the user authentication code, and performs the user authentication according to whether the generated user authentication code matches the received user authentication code.

12. The mutual authentication method as in claim 9, wherein the server authentication code generating operation generates the server authentication code by applying the secret information, which is contained in the user authentication code, to the authentication code generating function.

13. The mutual authentication method as in claim 9, wherein the user authentication code and the server authentication code are generated within a synchronization interval in which synchronization is conducted according to a network condition.
